(19) United States
(12) Patent Application Publication
(10) Pub. No.: US 2008/0236713 A1
(43) Pub. Date: Oct. 2, 2008

(54) Method and apparatus for teaching the installation of vehicle protective coverings

(76) Inventor: Stephen Costa, Laverne, CA (US)

Correspondence Address: JAMES E. BRUNTON, ESQ., P. O. BOX 29000, GLENDALE, CA, 91209, US

(21) Appl. No.: 12/080,593

(22) Filed: Apr. 3, 2008

Related U.S. Application Data
(63) Continuation-in-part of application No. 11/729,519, filed on Mar. 28, 2007.

(51) Int. Cl. B65D 65/02; G09B 29/00

(52) U.S. Cl. 150/166; 434/365

(57) ABSTRACT

A method and apparatus for teaching installers the proper technique for adhesively bonding a protective covering to an exterior portion of a vehicle. The apparatus of the invention includes a training cover constructed from a static-cling material and having the shape of the protective covering that is to be adhesively bonded to the exterior portion of the vehicle and one that can be easily removed from the automobile surface by applying a pulling force in a direction away from the vehicle.

This is a Continuation-In-Part of co-pending U.S. application Ser. No. 11/729,519 filed on Mar. 28, 2007.

### BACKGROUND OF THE INVENTION

1. Field of the Invention

The present invention relates generally to protective coverings that are applied to selected exterior portions of a vehicle. More particularly the invention concerns a method and apparatus for teaching installers the proper technique for affixing a protective covering to an exterior portion of a vehicle.

2. Discussion of the Prior Art

In the past it has been common practice to apply various types of protective coverings to selected exterior portions of vehicles such as automobiles and trucks. While various types of protective coverings have been suggested a common material that has been used for such purposes comprises a polyvinyl chloride in sheet form. Typically, the polyvinyl chloride sheet is cut into a number of different segments, each having a shape that substantially corresponds to the shape of the area being protected. For example, the segments may comprise a hood segment that has a shape substantially matching the hood area of the vehicle to be covered. Alternatively the segments may comprise bumper segments that have shapes substantially matching the shape of the bumper of the vehicle to be covered. After the various segments have been cut to the proper size, the segments are adhesively bonded to the appropriate vehicle surface through the use of a number of different types of adhesives, including pressure sensitive adhesives, such as adhesives sold by the Locite Corporation of Merington, Conn.

Proper installation of prior art protective coverings, such as those comprising polyvinyl chloride segments, typically require installation by experienced, well-trained installers. Because these prior art protective coverings are quite expensive, it is essential that the coverings be properly installed initially. If following an initial installation, the coverings are not smooth and free of bubbles, wrinkles and creases; the defective covering must be removed and discarded thereby resulting in substantial financial loss to the installer. It is this problem that the present invention addresses by providing a novel training method and apparatus that enables the installer to be successfully trained without risking the loss of expensive protective coverings. More particularly, in carrying out the method of the present invention, static-cling training segments carrying instructional indicia are used to train the installer in the proper techniques for successfully installing the more expensive, adhesively affixed protective coverings.

### SUMMARY OF THE INVENTION

It is an object of the present invention to provide a novel method and apparatus for teaching installers the proper technique for adhesively bonding a protective covering to an exterior portion of a vehicle.

Another object of the invention is to provide an apparatus of the aforementioned character that comprises a training cover having the shape of the protective covering that is to be adhesively bonded to the exterior portion of the vehicle and one that can be easily removed from the automobile surface by applying a pulling force in a direction away from the vehicle. More particularly, it is an object of the invention to provide a novel training cover that is constructed from a static-cling material that will releasably adhere to the surface of the vehicle.

Another object of the invention is to provide an apparatus of the character described in which the training cover has the general shape of a portion of the hood of a vehicle.

Another object of the invention is to provide an apparatus of the character described in which the training cover has the general shape of a vehicle bumper.

Another object of the invention is to provide a method for teaching installers the proper technique for adhesively bonding a protective covering to an exterior portion of a vehicle, which comprises the steps of first imprinting on an instructional display panel a plurality of instructions defining sequential actions to be taken by the installer in installing the protective covering and a plurality of individual indicia, each individual indicia corresponding to a selected one of the plurality of instructions. The next step in the method of the invention involves the construction of a training cover of the character previously described which has imprinted thereon a plurality of indicia corresponding to the indicia imprinted on the instructional display from a material that will releasably cling to the surface of the automobile. Following positioning of the training cover over a selected portion of the vehicle surface the trainee accomplishes the installation of the training cover by sequentially locating each of the reference indicia that have been imprinted upon the training covering and referring to the instruction imprinted on said training cover that corresponds to the located reference indicia.

Another object of the invention is to provide a method for teaching installers the proper technique for adhesively bonding a protective covering to an exterior portion of a vehicle, which comprises the steps of first imprinting on a training cover of the character previously described that is constructed from a material that will releasably cling to a smooth surface, a plurality of instructions defining sequential actions to be taken by the installer in installing the protective covering. The next step in this alternate method of the invention involves the positioning of the training cover over a selected portion of the vehicle surface. The trainee accomplishes the installation of the training cover by sequentially following the instructions imprinted on the training cover.

Still another object of the invention is to provide a method for teaching installers the proper technique for adhesively bonding a protective covering to an exterior portion of a vehicle, which comprises the steps of first imprinting on a training cover of the character previously described that is constructed from a material that will releasably cling to a smooth surface, a plurality of instructions defining sequential actions to be taken by the installer in installing the protective covering. The next step in this alternate method of the invention involves the positioning of the training cover over the protective cover to be installed on the automobile. Next, the combination thus constructed is positioned over a selected portion of the vehicle surface and the trainee accomplishes the installation of the training cover by sequentially following the instructions imprinted on the training cover. This done, the training cover is removed from the installed protective cover for reuse at another time.

Yet another object of the invention is to provide a method for teaching installers the proper technique for adhesively bonding a protective covering to an exterior portion of a vehicle, which comprises the steps of first using a removable ink, imprinting on a protective covering of the character previously described, a plurality of instructions defining sequential actions to be taken by the installer in installing the protective covering. The next step in this latest method of the invention involves the positioning of the imprinted training cover a selected portion of the vehicle surface. This done, the trainee accomplishes the installation of the training cover by sequentially following the instructions temporarily imprinted on the protective covering. With the imprinted protective covering installed on the vehicle, the next step in this latest form of the method of the invention is to remove the imprinted instructions from the training cover using suitable solvent.

These and other objects of the invention will be achieved by the method and apparatus of the invention that is described in greater detail in the paragraphs which follow.

### BRIEF DESCRIPTION OF THE DRAWINGS

FIG. 1 is a generally perspective, exploded diagrammatic view illustrating the manner of placement of a training covering over the hood portion of an automobile.

FIG. 2 is a generally perspective, diagrammatic view similar to FIG. 1 but showing the training covering in place over the hood portion of the automobile.

FIG. 3 is a top plan view of one form of the training covering of the apparatus of the present invention.

FIG. 4 is a generally diagrammatic view of one form of the instructional material of the apparatus of the present invention for use in connection with the training of the installer.

FIG. 5 is a top plan view of an alternate form of the training covering of the apparatus of the invention.

FIG. 6 is a top plan view of still another alternate form of the training covering of the apparatus of the invention.

FIG. 6A is a greatly enlarged view of the area designated as 6A-6A in FIG. 6.

FIG. 6B is a greatly enlarged view of the area designated as 6B-6B in FIG. 6.

FIG. 6C is a greatly enlarged view of the area designated as 6C-6C in FIG. 6.

FIG. 6D is a greatly enlarged view of the area designated as 6D-6D in FIG. 6.

FIG. 7 is a generally perspective, exploded view of yet another alternate form of the training apparatus of the invention.

FIG. 8 is a generally perspective view of form of the training apparatus of the invention shown in FIG. 7, but showing the static cling portion of the apparatus in engagement with the protective cover portion of the apparatus.

FIG. 9 is a generally perspective view of form of the training apparatus of the invention shown in FIG. 8, but showing the static cling portion of the apparatus being removed from the protective cover portion of the apparatus following installation of the protective cover portion.

FIG. 10 is a generally perspective, exploded view of still another alternate form of the training apparatus of the invention.

### DESCRIPTION OF THE INVENTION

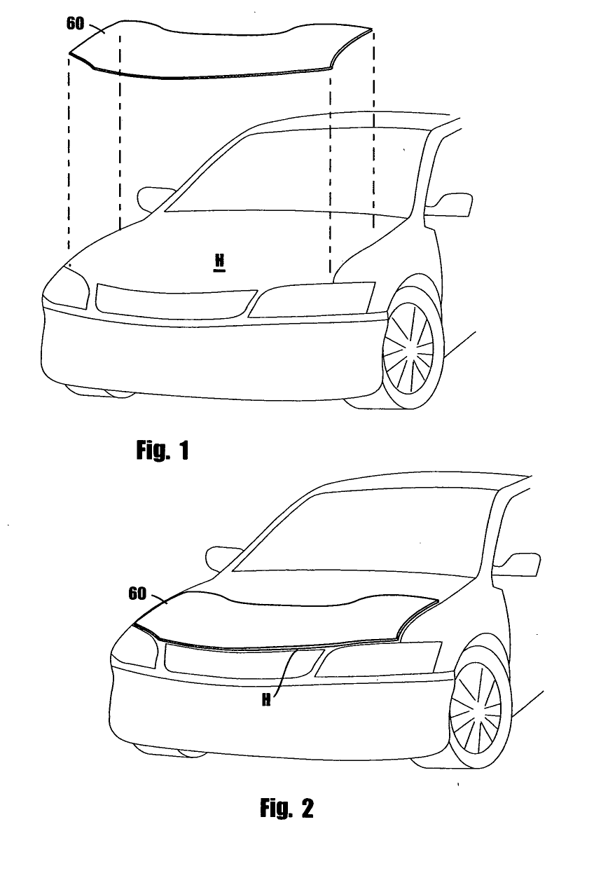

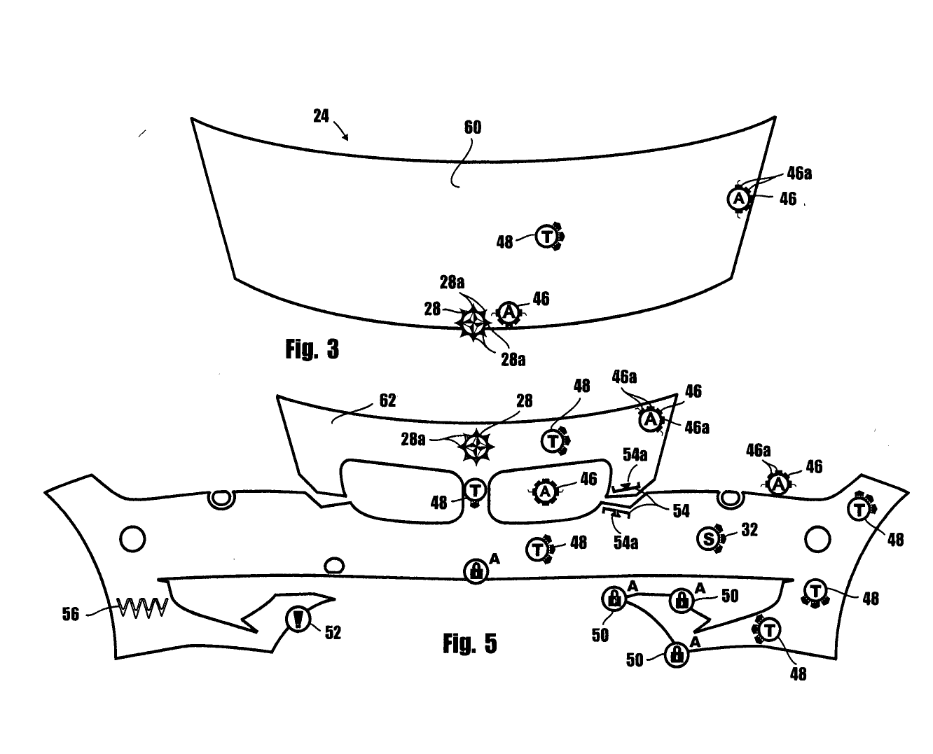

Referring to the drawings, and particularly to FIGS. 1 through 4, one form of the apparatus of the invention is there shown. The apparatus here comprises a plurality of cooperatively associated components that are specially designed for use in training an installer to successfully affix to a surface of the vehicle a protective covering having a shape generally corresponding to the shape of the portion of the vehicle. The principal components of the apparatus comprise a novel instructional display, here shown as a printed poster 22 (FIG. 4), and a training cover 24 (FIG. 3).

As illustrated in FIG. 4, the instructional display 22 comprises a poster constructed from a durable material, such as a plastic sheet having imprinted thereon data comprising a plurality of: instructions and a plurality of indicia corresponding to the instructions. More particularly, the data here comprises a first instruction 26 that concerns the starting point for the installation and first indicia 28 of unique design that corresponds to the first instruction. The instructional display also includes a second instruction 30 discussing stretch-direction of the training cover and a second indicia 32 of unique design that corresponds to the second instruction. In similar fashion, the instructional display includes third, fourth, fifth, sixth, seventh and eighth instructions 34, 36, 38, 40, 42 and 44 respectively. Each of these instructions provides specific information to the trainee concerning the sequential steps that are to be taken by the trainee to correctly position the training cover unto a portion of the vehicle. Associated with each of the instructions is a uniquely configured indicia identified in FIG. 4 by the numerals 46, 48, 50, 52, 54 and 56 respectively.

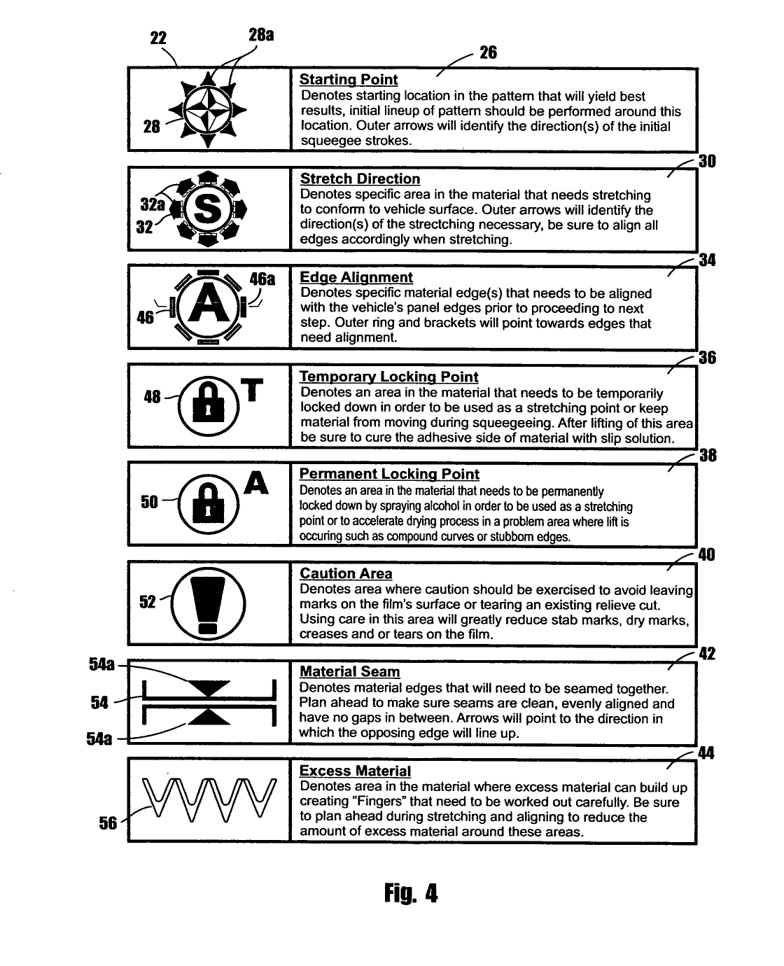

Referring to FIGS. 3 and 5, representative examples of training covers used in the accomplishment of the method of the invention are there shown and generally designated by the numerals 60 and 62. The training cover illustrated in FIG. 3 has a shape generally corresponding to the shape of the forward hood portion “H” of an automobile (see FIGS. 1 and 2). The training cover 62 illustrated in FIG. 5 has a shape substantially corresponding to the shape of the bumper portion of an automobile. As indicated in FIGS. 3 and 5, each of the training covers has imprinted thereon one or more of the reference indicia imprinted on the instructional display 22. More particularly, training cover 60 has imprinted thereon at strategically spaced-apart locations indicia 28, 46 and 48 which correspond to instructions 26, 34 and 36 that appear on the instructional display 22. Similarly training cover 62 has imprinted thereon indicia 28, 32, 46, 48, 50, 52, 54 and 56 which correspond to instructions 26, 30, 34, 36, 38, 40, 42 and 44 that appear on the instructional display 22.

Both of the training covers 60 and 62, as well as the training cover 66, which is used to train installers in the proper technique for installing a protective covering on the front surface of a bus “B”, are constructed from a substantially transparent material that will releasably cling to the surface of the vehicle and one that can be easily removed from the vehicle surface by applying a pulling force in a direction away from the vehicle. While several commercially available materials can be used to construct the training covers, a material offered for sale by the GMI Company of Calabasas Hills, Calif. has proven quite satisfactory.

Considering now the method of the invention for training an installer to successfully install a protective covering onto a vehicle, as previously discussed, because the high cost of producing the protective covering, the considerable time involved in properly installing a protective covering onto a vehicle and the great difficulty involved in properly installing a protective covering, pre-training of the installer is vitally important. In the past, training was typically on a “learn as you go” basis and was accomplished by the trainee attempting to actually install the particular protective covering. Due to the complexity of the installation process and the likelihood of faulty installation by an untrained installer, this approach often proved quite costly. It is this problem that is sought to be solved by the method and apparatus of the present invention, which allows training of the installer using a much less expensive training covering and one which can be used repeatedly.

In accordance with one form of the method of the present invention for training an installer to successfully install a protective covering onto a vehicle, the first step in the method involves the preparation of an instructional display of the character illustrated in FIG. 4 of the drawings. This step is accomplished by imprinting on a display panel in a conventional manner a plurality of instructions defining sequential actions to be taken by the installer in installing the protective covering and a plurality of individual indicia, each individual indicia corresponding to a selected one of the plurality of instructions.

The next step in the method of the invention involves the construction of a training cover from a material that will releasably cling to the surface of the automobile. The training covering has a shape substantially identical to the shape of the protective covering that is later to be installed and has printed thereon a plurality of reference indicia, each reference indicia corresponding to a selected one of the plurality of individual indicia imprinted on the instructional display.

Following the appropriate cleaning and drying of the vehicle, and following a careful study of the display panel, the trainee installer carefully places the training cover over the selected area of the vehicle. This done, the trainee sequentially locates each of the reference indicia that have been imprinted upon said training covering and refers to the instruction imprinted on said training cover that corresponds to the located reference indicia. More particularly, by locating on the training cover the symbol, or indicia 28, the trainee can determine the starting location on the pattern that will yield the best results for the training installation. As provided in the instructional material 26, the training cover is thus initially lined up in a manner such that installation is performed around this location. The outer arrows 28a formed on the indicia 28 identify the directions of the initial squeegee strokes that are to be performed by the trainee.

Next, the trainee locates on the training cover the indicia 32 which denote the specific areas in the material that require stretching so as to properly conform to the vehicle surface (FIG. 5). Once again, the outer arrows 32a of the indicia 32 indicate the directions of the necessary stretching of the training cover. Prior to accomplishing the stretching step, the trainee locates on the training cover the indicia 46 which denotes the specific material edges that are required to be aligned with the vehicle panel edges prior to proceeding to the next step. In this regard, the brackets 46a provided on the indicia 46 point towards the edges that require alignment. Also prior to accomplishing the training step, the trainee locates on the training cover the indicia 48 which denote the areas in the material that need to be temporarily locked down for use as a stretching point. Additionally, the trainee locates the indicia 50 that identify the areas that need to be permanently locked down by spraying alcohol on the area so that the area can be used as a stretching point or as a location to accelerate the drying process.

During the accomplishment of the installation process the trainee locates on the training cover the indicia 52 which denote areas where caution should be exercised to avoid leaving marks on the film surface and to avoid tearing of an existing relief cut in the covering. Additionally, by locating the indicia 54 on the training cover, the trainee can identify material edges that need to be seamed together. This enables the trainee to plan ahead to make certain that seams are clean, evenly aligned and have no gaps there between. The arrows 54a, which comprise a part of the indicia 54, indicate the directions in which the opposing edges will line up. Finally, by locating the indicia 56 on the training cover, the trainee can identify the areas in which the material excess can build up in a manner to create undesirable “fingers” that need to be carefully worked out.

After the trainee has completed installation of the training cover in accordance with the instructions set forth on the instructional display, the trainee supervisor inspects the installed training cover and points out to the trainee any errors that have been made during the training process as, for example, wrinkles or creases in the training cover, misaligned edges and the like. Following this review step with the trainee, the training cover is removed from the vehicle by applying a pulling force in a direction away from the vehicle. Due to the static-cling feature of the training cover, the cover can be removed from the vehicle a number of times and reused by the trainee or by other trainees. Through repeated training sessions in accordance with the methods set forth in the preceding paragraphs, the proficiency of the trainee can be continually improved until the trainee is capable of the proper installation of the more expensive protective covering that will remain on the vehicle.

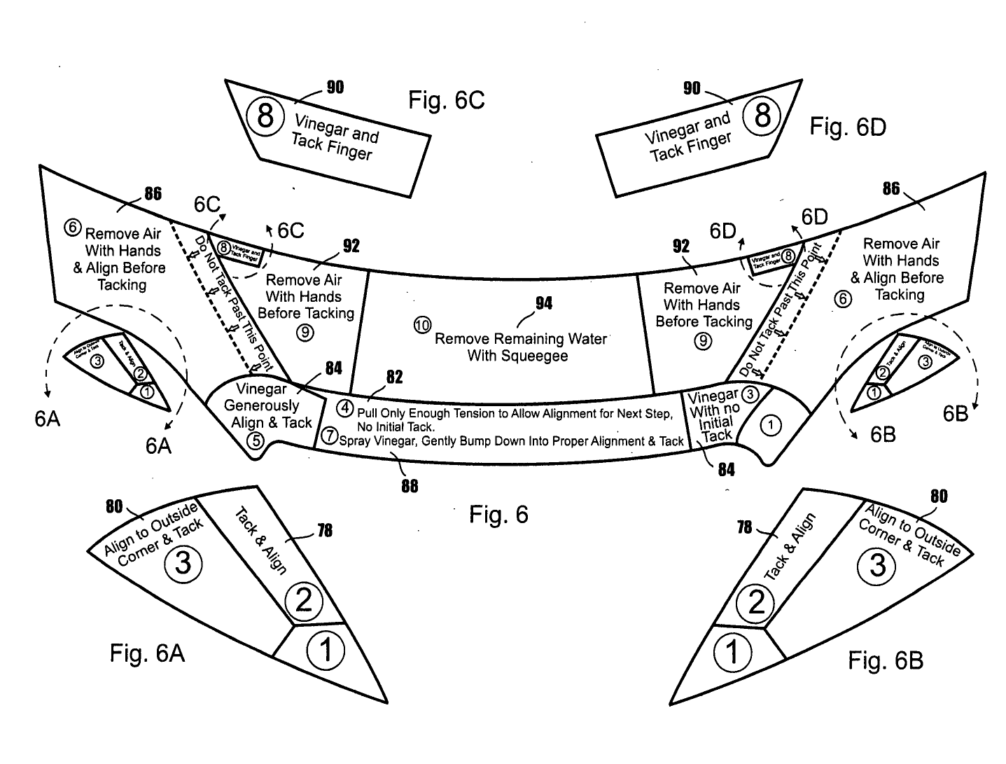

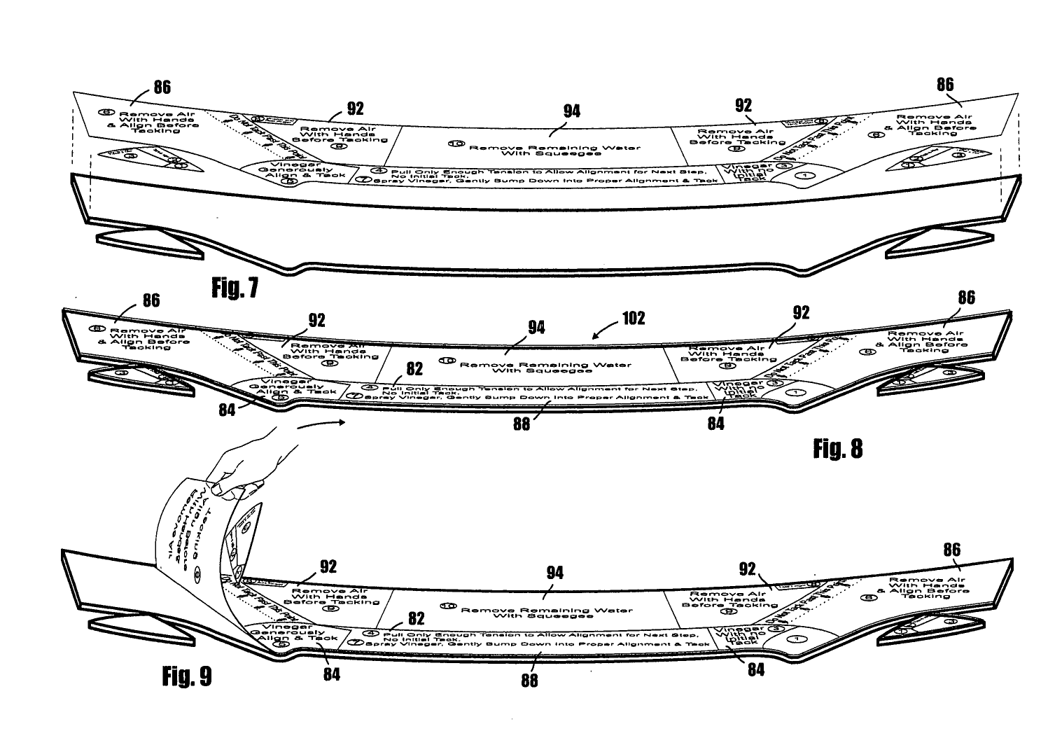

Referring next to FIGS. 6, 6A, 6B, 6C and 6D, an alternate form of the apparatus of the invention is there shown. The apparatus is similar in some respects to that previously described and, as before, comprises a plurality of cooperatively associated components that are specially designed for use in either installing the protective cover or training an installer to successfully affix to a surface of the vehicle a protective covering having a shape generally corresponding to the shape of the portion of the vehicle. The principal components of the apparatus of this latest form of the invention comprise a training cover 74 and a protective covering 76 (FIG. 7).

As illustrated in FIGS. 6, 6A, 6B, 6C and 6D, training cover 74 has a shape generally corresponding to the shape of the bumper portion of an automobile and has imprinted thereon a plurality of indicia that include the numerals 2 through 10. The imprinted indicia also comprises a plurality of printed installation instructions 78, 80, 82, 84, 86, 88, 90, 92 and 94 that are located at strategically spaced-apart locations and correspond to the numerals 2 through 10. As in the previously described embodiments of the invention, training cover 74 can be constructed from a substantially transparent material that will releasably cling to a generally smooth surface and comprises a cover that can be easily removed from the surface by applying a pulling force in a direction away from the surface. While several commercially available materials can be used to construct the training cover 74, a material offered for sale by the GMI Company of Calabasas Hills, Calif. has proven quite satisfactory for this purpose. Alternatively, cover 74 can be constructed from a thin flexible sheet material having an upper surface carrying the previously discussed installation instructions and a lower surface having an adhesive that will releasably grip the smooth surface such as the surface of a vehicle.

As indicated in FIGS. 6, 6A, 6B, 6C and 6D, the printed installation instructions 78 through 94, comprise instructions, such as starting points, alignment and tacking instructions, training cover pulling and stretching instructions, air removal instructions and similar instructions that provide detailed information to the trainee relative to the sequential steps that are to be taken by the trainee to correctly position the training cover unto the selected portion of the vehicle.

In using the apparatus illustrated in FIGS. 6, 6A, 6B, 6C and 6D to carry out an alternate method of the invention for training an installer to successfully install a protective covering onto a vehicle, the same steps as previously discussed are generally followed. As before, because of the high cost of producing the protective covering, the considerable time involved in properly installing a protective covering onto a vehicle and the great difficulty involved in properly installing a protective covering, pre-training of the installer using the apparatus of this latest form of the invention is vitally important. As in the earlier described methods of the invention, use of this latest embodiment of the invention allows training of the installer using a much less expensive training covering and one which can be used repeatedly.

More particularly, following the appropriate cleaning and drying of the vehicle the trainee installer carefully places the training cover 74 over the selected area of the vehicle. This done, the trainee sequentially locates each of the reference indicia that have been imprinted directly upon said training covering and in this way determines the starting location and the sequential installation steps that will yield the best results for installing the protective covering. Following review with the trainee of the training installation, the training cover is removed from the vehicle by applying a pulling force in a direction away from the vehicle. Due to the static-cling feature of the training cover, or the nature of the releasing adhesive, the cover can be easily removed from the vehicle and can be re-used a number of times by the trainee or by other trainees. Through repeated training sessions in accordance with the methods set forth in the preceding paragraphs, the proficiency of the trainee can be continually improved until the trainee is capable of the proper installation of the more expensive protective covering that will remain on the vehicle.

Turning now to FIGS. 7, 8 and 9 of the drawings, still another method of the invention using the cover 74 of the invention is there illustrated. In accordance with this latest method of the invention, instead of placing the cover 74 over the vehicle, the cover is placed over the upper surface of the protective covering 76 that is to be installed on the vehicle. With the cover 74 in position over the protective covering 76 in the manner shown in FIG. 8 of the drawings to form the assemblage 102 and, following the appropriate cleaning and drying of the vehicle, the assemblage 102 is carefully placed over the selected area of the vehicle that is to be protected. As before, the lower surface of the protective covering 76 is provided with a suitable adhesive.

In carrying out this alternate method of the invention, the installer, in the manner previously described, sequentially locates each of the reference indicia that have been imprinted directly upon the cover 74 and in this way determines the starting location and the sequential installation steps that will yield the best results for installing the protective covering 76 to which the cover 74 is removably attached. After the installation of the protective covering 76 onto the vehicle by following the instructional steps imprinted on the cover 74, the cover is removed from the now installed protective covering by applying a pulling force in a direction away from the protective covering. Due to the static-cling feature of the cover, the cover can be readily removed from the installed protective covering and reused on another occasion.

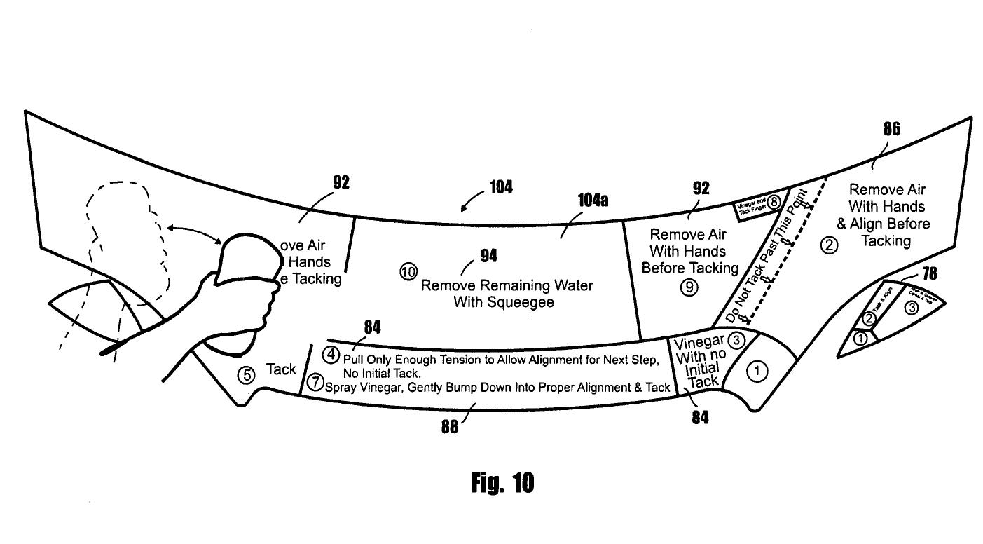

Referring finally to FIG. 10, yet another alternate form of the apparatus of the invention is there shown and generally identified by the number 104. This apparatus is also similar in some respects to that previously described and like numerals are used in FIG. 10 to identify like components. Apparatus 104 here comprises a unique protective covering 104a that has a shape substantially identical to the shape of protective covering 76. However, unlike protective covering 76, protective covering 104 has an upper surface 104a upon which instructional indicia is directly imprinted using an ink that can be easily removed using a suitable solvent. As before the indicia imprinted on upper surface 104a of the protective covering 104 comprises a plurality of indicia that include the numerals 1 through 10 and a plurality of written installation instructions 78, 80, 82, 84, 86, 88, 90, 92 and 94 that correspond to the numerals 2 through 10. As before, the lower surface of the protective covering 104 is provided with a suitable adhesive.

In carrying out this latest method of the invention, following the appropriate cleaning and drying of the vehicle, the installer carefully places the protective cover 104 over the selected area of the vehicle. This done, the trainee, in the manner previously described, sequentially locates each of the reference indicia that have been imprinted directly upon the protective cover and in this way determines the starting location and the sequential installation steps that will yield the best results for installing the protective covering 104.

Following installation of the protective cover in the manner described, the imprinted indicia are removed from the protective cover using any suitable solvent.

It is to be understood that instead of imprinting the indicia on the protective cover 104 using a removable ink, a suitable disappearing ink, such as that available from Black Light World of Cub Run, Ky., can be used.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. An apparatus for use in protecting a portion of the surface of a vehicle, said apparatus comprising:
(a) a protective covering having a shape generally corresponding to the shape of the portion of the vehicle to be protected, said protective covering having an upper surface and a lower surface having an adhesive coating thereon; and
(b) a cover removably connected to said upper surface of said protective covering, said cover having a plurality of installation instructions imprinted thereon.

2. The apparatus as defined in claim 1 in which said cover is constructed from a material that will releasably cling to said upper surface of said protective covering.

3. The apparatus as defined in claim 1 in which said cover is constructed from a material that can be easily removed from said upper surface of said protective covering.

4. The apparatus as defined in claim 1 in which said cover is substantially transparent.

5. The apparatus as defined in claim 1 in which said protective covering has the general shape of a portion of the bumper of the vehicle and in which said cover has the general shape of said protective covering.

6. The apparatus as defined in claim 1 in which said installation instructions imprinted on said cover comprise a plurality of spaced apart numbers and a plurality of spaced apart installation instructions.

7. An apparatus for use in protecting a portion of the surface of a vehicle, said apparatus comprising a protective covering having a shape generally corresponding to the shape of the portion of the vehicle to be protected, said protective covering having an upper surface and a lower surface having an adhesive coating thereon, said upper surface having a plurality of installation instructions removably imprinted thereon.

8. The apparatus as defined in claim 7 in which said installation instructions removably imprinted on said upper surface of said cover comprise a plurality of spaced apart numbers and a plurality of spaced apart written installation instructions.

9. The apparatus as defined in claim 8 in which said installation instructions are imprinted on said upper surface of said cover using an ink that can be removed using a suitable solvent.

10. An apparatus for use in protecting a portion of the surface of a vehicle, said apparatus comprising a protective covering having a shape generally corresponding to the shape of the portion of the vehicle to be protected, said protective covering having:
(a) an upper surface having installation instructions removably imprinted thereon, said installation instructions comprising a plurality of spaced apart numbers and a plurality of spaced apart written installation instructions; and
(b) a lower surface having an adhesive coating thereon.

11. The apparatus as defined in claim 11 in which said installation instructions are removably imprinted on said upper surface of said cover using an ink that can be removed using a suitable solvent.
